(19) United States
(12) Patent Application Publication
(10) Pub. No.: US 2026/0249376 A1
(43) Pub. Date: Aug. 27, 2026

(54) WELDING SYSTEM AND METHODS

(71) Applicant: Pacific Shipyards International, LLC, HONOLULU, HI (US)

(72) Inventors: Pete Proehl, Bellevue, WA (US); Nissa Van Meter, Brier, WA (US); Nikolai Herrera, Kailua, HI (US); Michael Buelsing, Honolulu, HI (US); Dan Abbott, Maple Valley, WA (US)

(21) Appl. No.: 19/547,501

(22) Filed: Feb. 23, 2026

Related U.S. Application Data
(60) Provisional application No. 63/762,563, filed on Feb. 24, 2025.

(51) Int. Cl. B23K 9/095

(52) U.S. Cl. CPC B23K 9/0956; B23K 9/0953

(57) ABSTRACT

Welding systems and methods are disclosed. The welding system includes an optical assembly configured to image a welding site at a frame rate. The images are automatically processed according to whether an arc is present in the image, and displayed for view by the operator of the welding system.

### CROSS REFERENCE TO RELATED APPLICATION

The present application claims priority to U.S. Provisional Application No. 63/762,563 entitled WELDING SYSTEM AND METHODS filed February 24, 2025. The entire content of the above application is hereby incorporated by reference for all purposes.

### GOVERNMENT SUPPORT

This invention was made with Government support under Agreement No. N00024-18-3-2231 awarded by the Naval Sea Systems Command (NAVSEA). The Government has certain rights in the invention.

### TECHNICAL FIELD

The present description relates generally to a welding system and methods for operating the welding system.

### BACKGROUND AND SUMMARY

An operator of welding equipment may not be able to adequately view the welding site while welding by direct eyesight alone. Use of an optical device (e.g., camera) to image the welding site and display the images in real time as a video may aid the visibility of the welding site. However, differences in contrast, brightness, and relative darkness between images including an arc and images not including an arc may make objects in the displayed images unclear, as different camera settings may be demanded to optimize image quality under high and low exposure conditions.

Thus, a welding system and method for operating the welding system are disclosed herein to address at least some of the issues described above, which are identified by the inventors herein. In one example, the method for operating the welding system may comprise producing an arc periodically while welding two components together at a welding site; determining three or more different parameter sets; producing images of the welding site at a frame rate; and processing the images by applying one or more of the three or more different image parameter sets according to whether an arc is present in the images. In this way, the visual information gathered by the optical assembly may be displayed for view of the operator while welding such that visibility of the welding site is increased, thereby allowing more precise welding operations. Processing according to whether an arc is present may increase quality of the images by automatically adjusting the image parameters for high and low exposure conditions.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic diagram of a welding system.

FIGS. 2A and 2B show an example of a welding device including a welding assembly and an optical assembly coupled by a mount assembly.

FIG. 3 shows a closer view of the welding device.

FIG. 4 shows the mount assembly.

FIG. 5 shows the mount assembly in an exploded view.

FIG. 6 shows another view of the welding device.

FIGS. 7A and 7B show an optical housing of the mount assembly.

FIG. 8 shows an exploded view of the optical assembly.

FIGS. 9A and 9B show views of the optical assembly.

FIG. 10 shows the optical assembly and the mount assembly.

FIG. 11 shows a block diagram of the optical assembly.

FIG. 12 shows a flowchart of a method for operating the welding system.

FIG. 13 shows a flowchart of a method for processing images according to whether an arc is present while operating the welding device.

FIG. 14 shows a flowchart of a method for determining a region of the images where an arc is present.

FIG. 15 shows a flowchart of a method for processing images including an arc.

### DETAILED DESCRIPTION

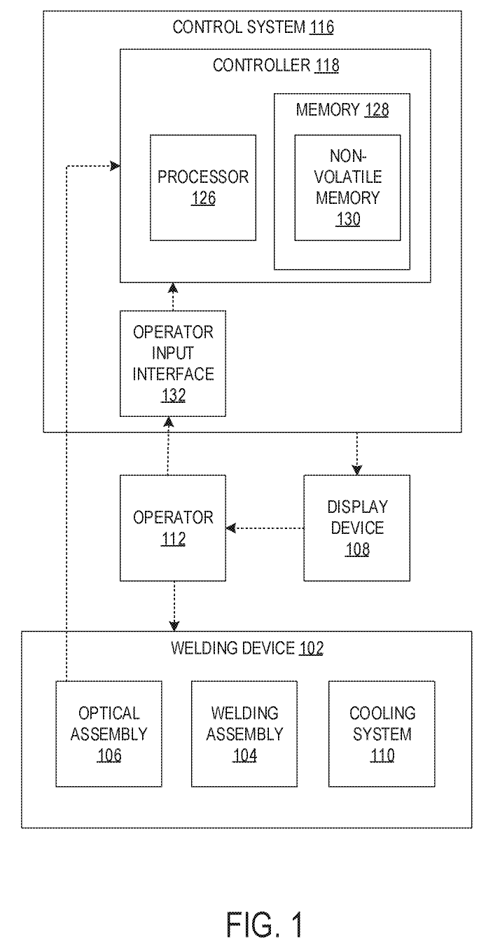

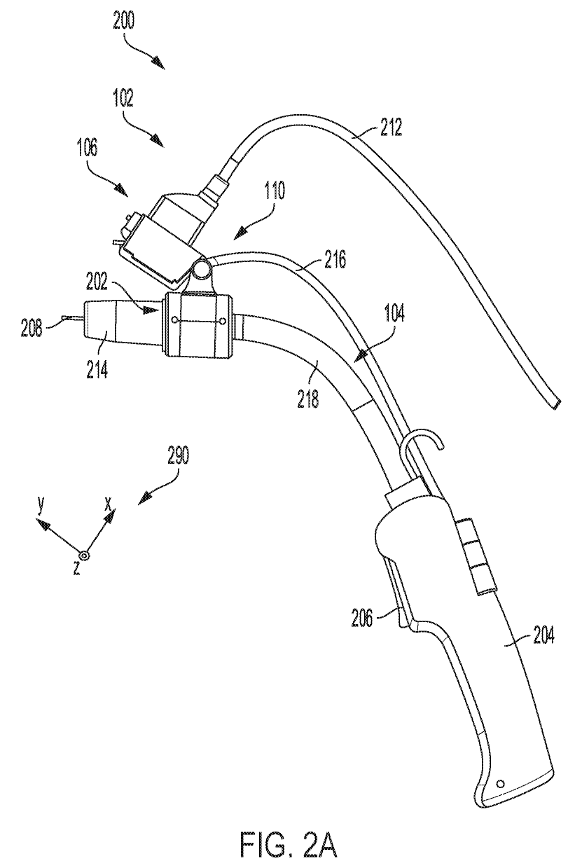

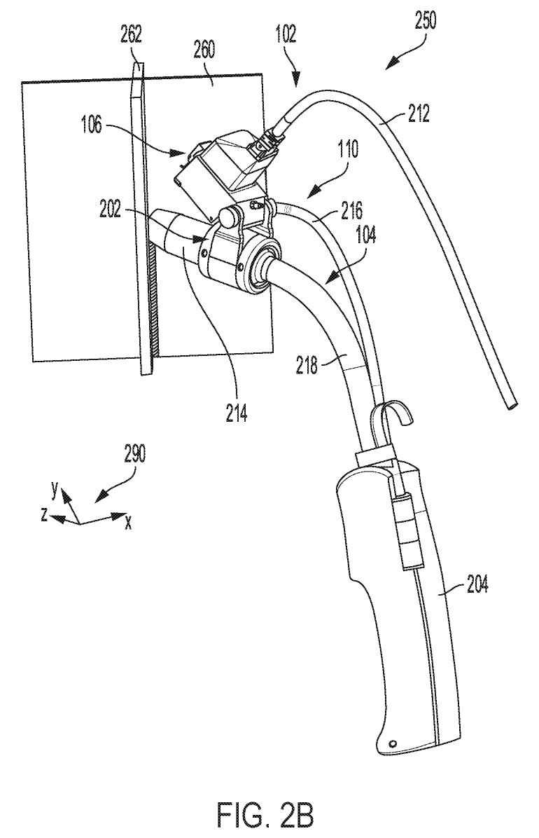

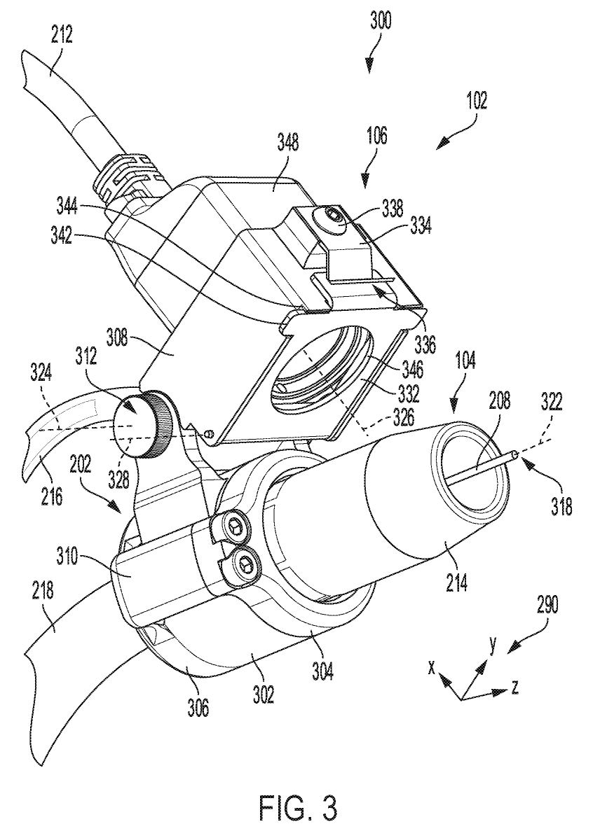

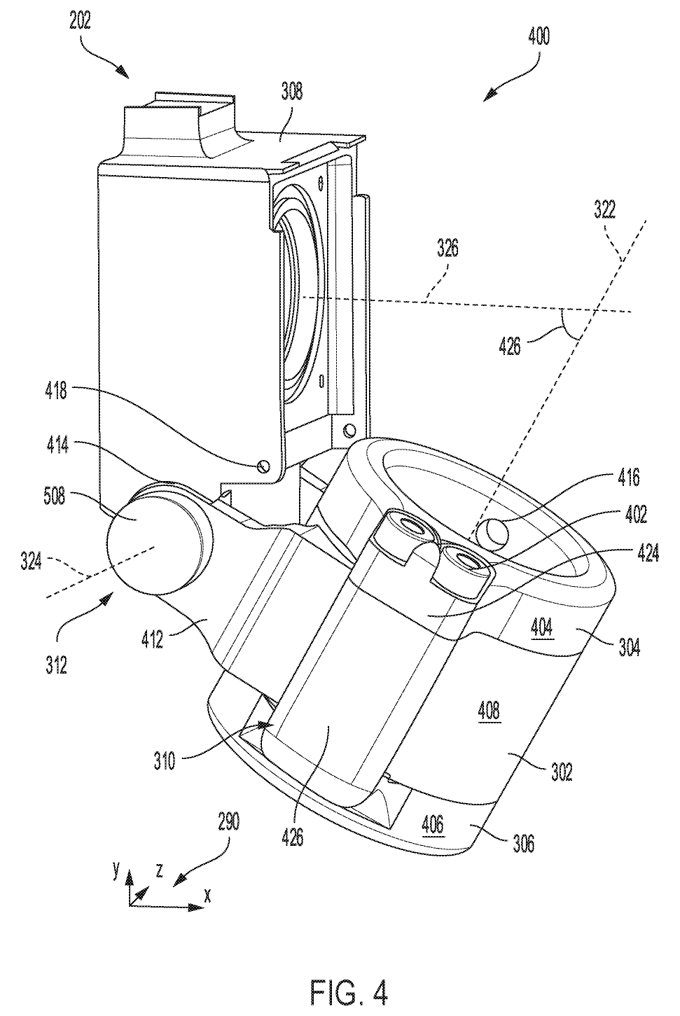

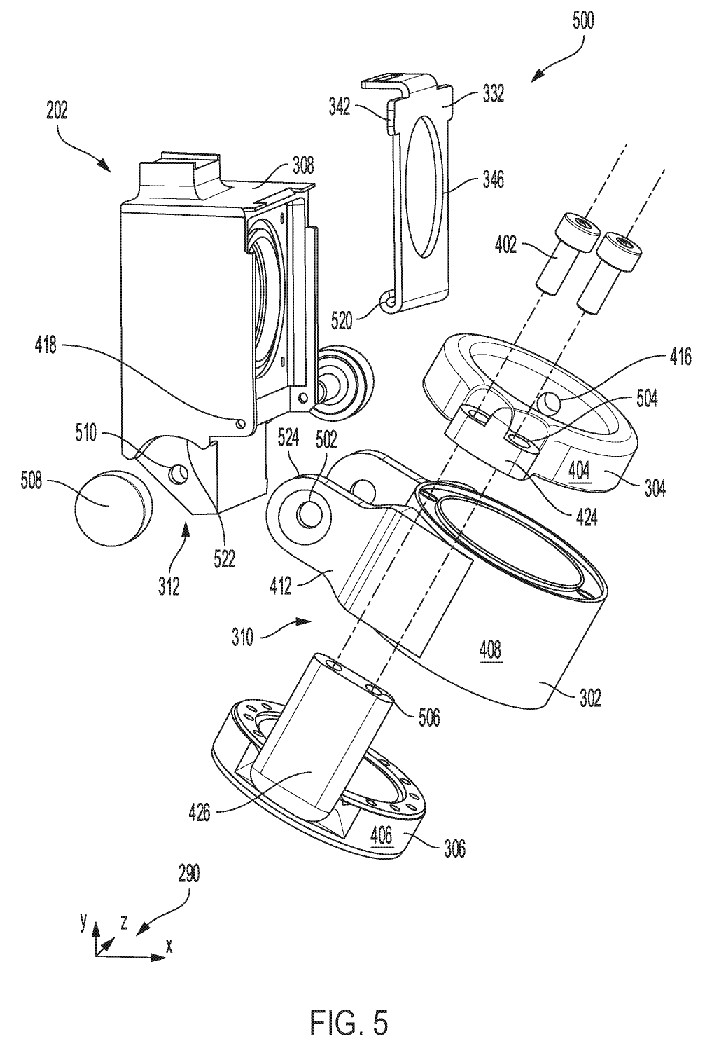

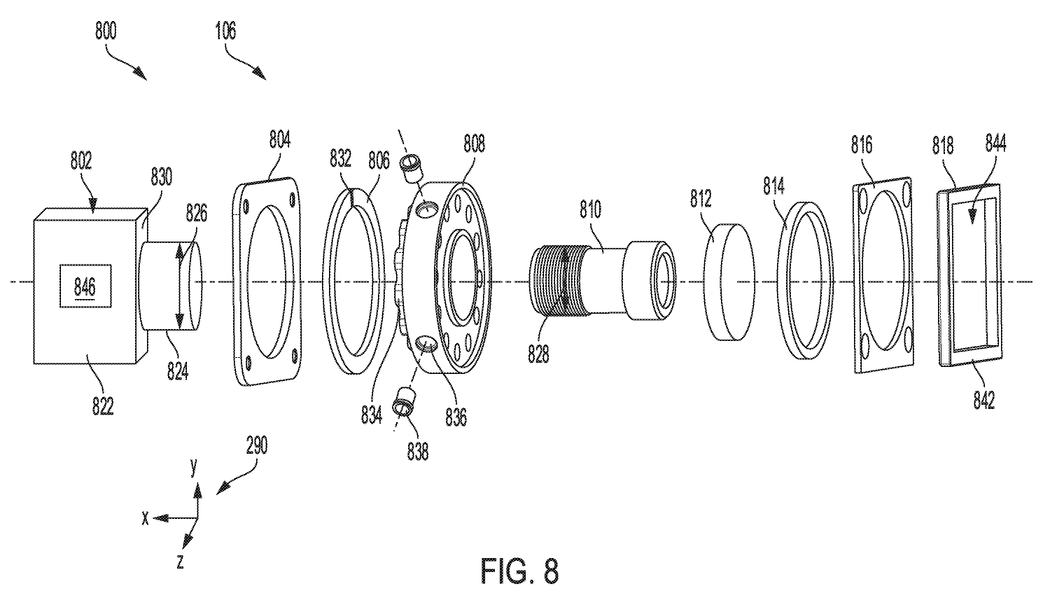

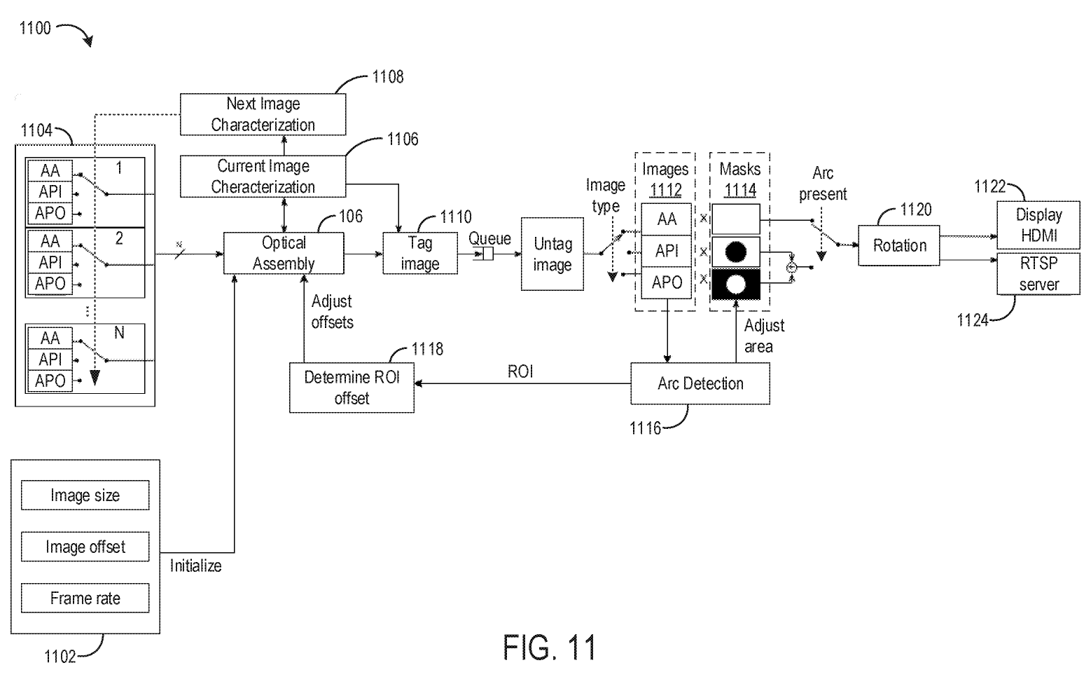

The following description relates to systems and methods for welding. Specifically, the welding operation may be imaged and displayed for view by the operator of the welding equipment to increase visibility of the welding site where welding occurs. An example of a welding system is shown schematically in FIG. 1. An example of a welding device of the welding system is shown in FIGS. 2A and 2B, and further shown in FIGS. 3-10. Specifically, an optical assembly of the welding device configured to image the welding site is shown in FIGS. 8-10. The optical assembly may be coupled to a welding assembly of the welding device via a mount assembly of the welding device. The mount assembly is further shown in FIGS. 4 and 5. Methods for operating the welding system are shown as flowcharts in FIGS. 11-15.

It is to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

Turning to FIG. 1, a welding system 100 is shown schematically. The welding system 100 comprises a welding device 102. The welding device 102 may be configured to be operated in order to weld components together via one of various arc welding types including gas metal arc welding, gas tungsten arc welding (also known as tungsten inert gas welding), shielded metal arc welding, flux cored arc welding, submerged arc welding, plasma arc welding, and the like. As such, the welding device 102 may include a welding assembly 104. The welding assembly 104 may also be referred to as an arc welding assembly due to the production of an arc during operation. An operator 112 may operate the welding device 102 to join two or more parts (e.g., metal parts) by heating (e.g., melting) the parts. Specifically, the welding operation (e.g. operation of the welding device 102) may produce an arc via electricity flowing through the welding device 102.

The welding device 102 may further include an optical assembly 106. The optical assembly 106 may include an optical device configured for capturing visual data (e.g., images), such as a camera. Specifically, the optical assembly 106 may image a welding site at a frame rate (e.g., a number of images per time) during operation of the welding assembly 104 in order to provide additional visual insight to the operator 112. For example, details of the welding site may not be distinguishable by direct eyesight of the operator 112 due to the brightness of the arc which may appear periodically during welding. That is, the arc, when present, may be in high contrast with the surrounding area, making it difficult for the operator 112 to view the arc and the surrounding area simultaneously. Such details may be more easily discerned when supplementing eyesight of the operator 112 with visual information provided by the optical assembly 106. As an example, the optical assembly 106 providing a visual of different areas (e.g., the arc area and the surrounding area) with different image processing parameters (e.g., exposure, brightness, etc.) may allow for the operator 112 to visualize both the arc and the surrounding area with increased clarity when the arc is present. However, such parameters tuned for optimized visualization of the arc and surrounding area may not be appropriate for images where an arc is not present. Thus, the methods disclosed herein may include identifying whether an arc is present in each image and applying parameters to the image accordingly, allowing the operator 112 to view the weld area before, during, and following a period where an arc is present with parameters automatically optimized in real-time.

The welding system 100 may further comprise a control system 116 configured to execute the methods herein. The control system 116 includes a controller 118. The control system 116 may further include an operator input interface 132. The operator input interface 132 may include one or more buttons, knobs, switches, dials, touch screens, a combination thereof, or the like. The operator 112 may manually input commands via the operator input interface 132. For example, manually inputted commands may include updates to optical assembly settings such as image rotation, brightness, etc. of the images provided by the optical assembly 106. The controller 118 may be communicatively coupled to the operator input interface 132. Specifically, the operator input interface 132 may send electrical signals to the controller 118 corresponding to the manually inputted commands. In some examples, the control system 116 may further include one or more of each of sensors and actuators configured for automated control of the welding system 100. For example, command signals sent to the actuators may be generated by the controller 118 in response to electrical signals received from the operator input interface 132 and/or the sensors.

The controller 118 may include a processor 126 and memory 128. The memory 128 includes non-volatile memory 130. The memory 128 may further include other memory forms such as random access memory. The controller 118 may include instructions stored in the non-volatile memory 130, where the instructions are executable (e.g., by the processor 126) to perform methods described herein. For example, visual data may be transmitted from the optical assembly 106 to the controller 118 (e.g., via electrical signals) and processed by performing a method of the present disclosure. Performing such methods may transform the visual information (e.g., by rotating, cropping, applying masks, etc.) into a format that is more easily visible by the operator 112 according to whether an arc is present.

After being processed by the controller 118, the visual information may be displayed on a display device 108 for view by the operator 112. The images may be captured at a sufficiently high frame rate (e.g., in a range of 25-180 frames per second) such that the visual information appears to the operator 112 as a video displayed in real-time or near real-time. The display device 108 may be a wearable device (e.g., pair of glasses, headset, etc.) configured for augmented reality display, in one example. Thus, the display may add to the vision of the operator 112 without obstructing the view of their surroundings. The display device 108 may further be configured for eye protection of the operator 112. In this way, the operator 112 may view the display through protective equipment already generally worn by the operator 112, though other display configurations where the display device 108 is separate from protective equipment worn by the operator 112 are also possible. In another example, the display device 108 may be configured for a virtual reality display.

The welding device 102 may further comprise a cooling system 110. The cooling system 110 may provide air circulation to reduce (e.g., prevent) accumulation of debris on the optical assembly 106 (e.g., on a lens thereof) which may obscure the welding site from the perspective of the optical assembly 106, decreasing quality of the visual data gathered by the optical assembly 106. As used herein, air may include atmospheric gas (e.g., oxygen, nitrogen, carbon dioxide, methane, water vapor, etc.), and/or one or more other gasses. The cooling system 110 is described in greater detail below.

Turning to FIGS. 2A and 2B, the welding device 102 is shown in a first view 200 and a second view 250. A set of reference axes 290 is shown in FIGS. 2A and 2B, as well as FIGS. 3-10, for comparison of orientations shown therein. The reference axes 290 include an x-axis, a y-axis, and a z-axis.

The wedding assembly 104 of the welding device 102 may include conventional components such as a handle 204, a button 206, a nozzle 214, a connector 218 extending between the handle 204 and the nozzle 214, and an electrode 208. The operator (e.g., operator 112 of FIG. 1) may hold the welding device 102 by the handle 204. The operator may further apply pressure to the button 206 such that the button is depressed into the handle 204 in order to initiate electrical flow through the welding device 102, thereby forming an arc at the electrode 208. The welding assembly 104 may further be coupled to a power transmission cord (not shown) wherethrough electrical power is provided to the welding assembly upon initiation via the button 206. Two components 260, 262 (e.g., metal pieces such as metal plates) may be positioned at the electrode 208 as shown in FIG. 2B, and welded together as a consequence of the arc produced by the welding assembly 104 on command of the operator. As such, a clear visual of the two components 260, 262 and relative position of the electrode 208 for the operator may ensure the desired welding configuration is achieved. The welded components 260, 262 are omitted from FIG. 2A for clarity.

The welding device 102 further includes the optical assembly 106, as described above, which is coupled to the welding assembly 104 via a mount assembly 202 in order to enhance the visual of the welding device 102 relative to the components being welded thereby. The optical assembly 106 may be communicatively coupled to a controller (e.g., controller 118 of FIG. 1) via an optical cord 212. That is, electrical signals may be sent from the optical assembly 106 to the controller and/or vice versa via the optical cord 212.

An air tube 216 may extend from the cooling system 110 to an air supply system. For example, the air supply system may be a conventional shop air supply configured to deliver pressurized air flow to the welding device 102 via the air tube 216 and/or other systems when coupled thereto. In another example, the air supply system may be an individual system specific to the welding system 100.

The mount assembly 202 which physically couples the welding assembly 104 and the optical assembly 106 may allow rotation of the optical assembly 106 relative to the welding assembly 104 about one or more axes of rotation, as described further below. As such, there are several configurations of the welding device 102, and it will be understood that the reference axes 290 are shown herein specifically corresponding to the orientation of the optical assembly 106.

Turning to FIG. 3, a closer view 300 of part of the welding device 102 is shown. The view 300 is specifically focused on the optical assembly 106, the mount assembly 202, the nozzle 214, and the electrode 208.

The mount assembly 202 may include a yoke 302, a first nozzle mount 304, and a second nozzle mount 306. The yoke 302 and the nozzle mounts 304, 306 may circumferentially surround the nozzle 214. The yoke 302 may be axially interposed between the nozzle mounts 304, 306. The nozzle mounts 304, 306 may be fixedly coupled to the nozzle 214 such that relative motion between the nozzle mounts 304, 306 and the nozzle 214 is minimized (e.g., does not occur intentionally). The yoke 302 may be rotationally free from the nozzle 214. The yoke 302 may be coupled to the nozzle mounts 304, 306 via a fastening system 310 that allows relative rotational motion of the yoke 302 relative to the nozzle mounts 304, 306 about a first rotational axis 322 when the fastening system 310 is not tightened. Then the fastening system 310 is tightened, the yoke 302 may not be allowed to move (e.g., rotate or shift) relative to the nozzle mounts 304, 306. The rotational axis 322 may extend concentrically through the electrode 208.

The mount assembly 202 may further include an optical housing 308 which may house one or more components of the optical assembly 106, which are described further below. The optical housing 308 may be coupled to the yoke 302 via one or more joints 312 which allow relative rotational movement about a second rotational axis 324 when the joints 312 are not tightened. The second rotational axis 324 may be normal to the first rotational axis 322.

The optical assembly 106 may image an area surrounding an optical line 326. That is, the optical line 326 may be centrally located with respect to the field of view of the optical assembly. The operator (e.g., operator 112 of FIG. 1) may manually adjust the fastening system 310 and the joints 312 in order to position the optical line 326 relative to the first rotational axis 322 and the second rotational axis 324 as desired. For example, adjusting the joints 312 may adjust an angle formed between the optical line 326 and the first rotational axis 322. Further, adjusting the fastening system 310 may allow rotation of the optical line 326 about the first rotational axis 322. It may be that the desired position is as shown in FIG. 3, as an example. Alternatively, the desired position may include a position where the first rotational axis 322 and the optical line 326 intersect proximate to an end 318 of the electrode 208. Additionally or alternatively, the desired position of the mount assembly 202 may be dependent on the welding assembly 104 configuration and/or the components being welded. For example, the mount assembly 202 and optical assembly 106 may be interchangeably attached to two or more different welding assemblies (e.g., configured for different welding types, different dimensions such as electrode length, etc.). The adjustability of the mount assembly 202 may allow for such modular use so as to be compatible with various welding assembly configurations.

A cover 332 may be coupled to the optical housing 308. The cover 332 may be removable from (e.g., removably coupled to) the optical housing 308. Removably coupled components may be reversibly removable without causing degradation. Specifically, the cover 332 may be coupled 332 to the optical housing 308 via a hinge which allows pivotal rotation about a third rotational axis 328 parallel to the second rotational axis 324. Such hinge movement may allow access to components within the optical housing 308 on demand, such as for maintenance (e.g., cleaning, repairs, etc.), while enclosing the components during use (e.g., during a welding operation). Upon adjustment of the joints 312, the third rotational axis 328 may shift circumferentially around the second rotational axis 324. The cover 332 may be held in place relative to the optical housing 308 by a clip 334. For example, the clip 334 may be received by an opening 336 (e.g., indent, recess, hole, or the like) of the cover 332 when secured (e.g., in a secured position). In the secured position, the cover 332 may be flush with the optical housing 308. For example, the cover 332 and the optical housing 308 may include complementarily shaped features such as protrusions 342 and recesses 344 which support alignment of the cover 332 flush with the optical housing 308. When released (e.g., in a released position), the clip 334 may be spaced away from the opening 336. The clip 334 may be attached to the optical housing 308 via a fastener 338 extending through the clip 334 and the optical housing 308 such as a screw, bolt, etc., in one example. However, the clip 334 may instead be integral with the optical housing 308 or otherwise fixed thereto via adhesive, welding, or any other fastening means without departing from the scope of the present disclosure. Further, the cover 332 may be reversibly rotationally fixed to the optical housing 308 by other systems additionally or alternatively to the clip 334, including additional clips, snaps, spring loaded buttons (e.g., where a button is pressed to release as opposed to a clip being pulled), or the like.

The cover 332 may comprise an opening 346. The opening 346 may be a through-hole in a surface of the cover 332 wherethrough one or more of the components within the optical housing 308 may be exposed. As an example, the opening 346 may be circular as shown. However, the opening 346 may be any other shape, including polygonal, without departing from the scope of the present disclosure. The opening 346 may be centered about the optical line 326. That is, the optical line 326 may extend through a center of the opening 346. Further, the optical line 326 may extend normal to the cover 332, when in the secured position.

The optical housing 308 may be interposed between the cover 332 and a second cover 348. The second cover 348 may be configured to protect a coupling between the optical cord 212 and the optical assembly 106 from debris, including dust, dirt, and the like, which may otherwise interfere with the coupling. In one example, the coupling may be a locking micro Universal Serial Bus (USB) coupling. However, other optical cord 212 configurations are possible. Further, in some examples, the optical cord 212 may be omitted such that a wireless connection is established between the optical assembly 106 and the controller (e.g., controller 118 of FIG. 1).

Turning to FIGS. 4 and 5, a perspective view 400 and an exploded view 500 of the mount assembly 202 are respectively shown. The mount assembly 202 includes the yoke 302, the first nozzle mount 304, the second nozzle mount 306, and the optical housing 308, as well as one or more fasteners described further below. FIG. 5 further shows the cover 332.

As noted above, the fastening system 310 may adjustably couple the yoke 302 with the nozzle mounts 304, 306. For example, the first nozzle mount 304 and the second nozzle mount 306 may respectively include first through-holes 504 and second through-holes 506 wherethrough nozzle mount fasteners 402 may extend to rotationally and axially affix the nozzle mounts 304, 306 relative to each other. The nozzle mount fasteners 402 may not interact with the yoke 302 such that the yoke 302 may rotate freely of the nozzle mounts 304, 306 in the absence of sufficient compressive force applied by the nozzle mount fasteners 402 when tightened to compress the yoke 302 between the nozzle mounts 304, 306. For example, the first and second through-holes 504, 506 may be formed in first and second radial protrusions 424, 426, respectfully of the first and second nozzle mounts 304, 306. Regardless of the rotational position of the yoke 302, a first surface 408 thereof may be flush with a second surface 404 of the first nozzle mount 304 and a third surface 406 of the second nozzle mount 306. The surfaces 404, 406, 408 may be cylindrical, for example. The radial protrusions 424, 426 may extend radially from the surfaces 404, 406 at least far enough to not obstruct rotational movement of the yoke 302 when the fastening system 310 is not tightened.

The yoke 302 may further include one or more extensions 412. As an example, the yoke 302 is shown herein with two extensions 412, one positioned on each side of the optical housing 308 along the second axis 324. The extensions 412 may extend parallel to each other outward from the surface 408. Additionally or alternatively, the extensions 412 may extend tangential to the surface 408. The extensions 412 may each comprise a yoke extension opening 502 adapted to receive an optical housing fastener 508. The optical housing fasteners 508 may be further received by optical housing openings 510 of the optical housing 308 aligned therewith along the second rotational axis 324, thereby forming the joints 312. As described above, the optical housing 308 may be rotated via the joints 312 about the second axis of rotation 324, which extends through the openings 502, 510, relative to the yoke 302 in order to adjust the optical line 326 position. Moving the optical line position 326 in this way changes an angle 426 between the first axis of rotation 322, which extends concentrically through the yoke 302 and the nozzle mounts 304, 306, and the second axis of rotation 324, thereby adjusting a frame of view imageable by the optical assembly (e.g., optical assembly 106) at least partially housed by the optical housing 308. The angle 426 may remain between zero degrees and ninety degrees to ensure the welding area (e.g., area where the components 260, 262 are joined) coincides with the frame of view such that the welding area appears in the images captured by the optical assembly housed within the optical housing 308.

At an interface 414 where the optical housing 308 and the yoke extensions 412 are in face-sharing contact, radii of curvature of a first curved surface 522 and a second curved surface 524 respectively thereof may be approximately equal. In this way, during adjustment of the joints 312, the interface 414 may shift circumferentially along the surface 524 as the optical housing 308 slides smoothly therealong.

The optical housing 308 may include features complementary to the cover 332 described above, such as holes 418 adapted to receive protrusions of the cover 332 or fasteners coupled thereto (e.g., a fastener extending through a receptacle 520 such as a mostly enclosed groove, blind-hole, through-hole, etc.). Likewise, one or both of the nozzle mounts 304, 306 may include features complementary to the nozzle 214, such as holes 416 adapted to receive protrusions of the nozzle 214 or fasteners coupled thereto.

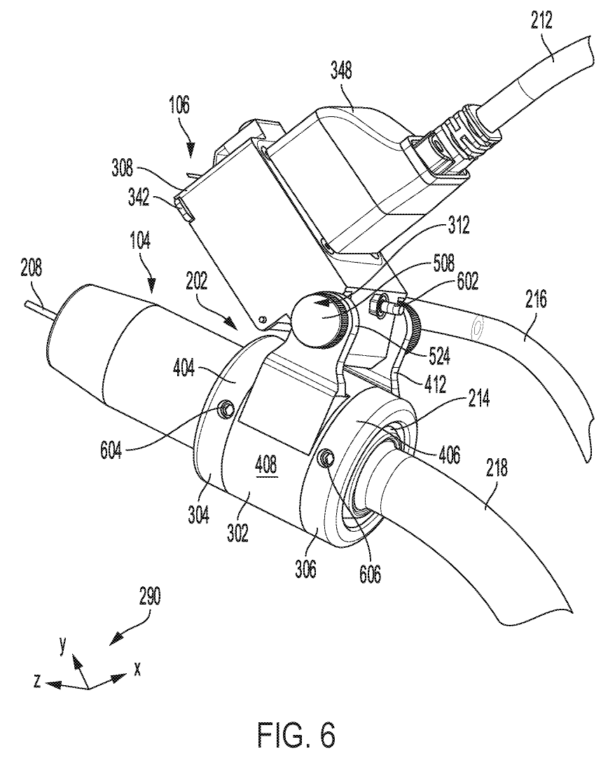

For example, turning briefly to FIG. 6, a first nozzle fastener 604 may couple the first nozzle mount 304 to the nozzle 214, and a second nozzle fastener 606 may couple the second nozzle mount 306 to the nozzle 214. Further, as shown in FIG. 6, an air tube port 602 may fluidly couple the interior of the optical housing 308 and the air tube 216, allowing pressurized air to flow through the air tube 216 into the optical housing 308, for example for purposes of cooling of components positioned therein.

In this way, returning to FIG. 3, the mount assembly 202 may physically couple the welding assembly 104 with the optical assembly 106 with one or more degrees of rotational freedom, allowing customization to various welding configurations (e.g., different welding assemblies). Although described as manually adjustable herein, it has been envisioned that the joints 312 and/or the fastening system 310 may be controlled automatically, for example via commands generated by the controller 118 of FIG. 1 in response to stimuli monitored by sensors and/or content of the images produced by the optical assembly 106.

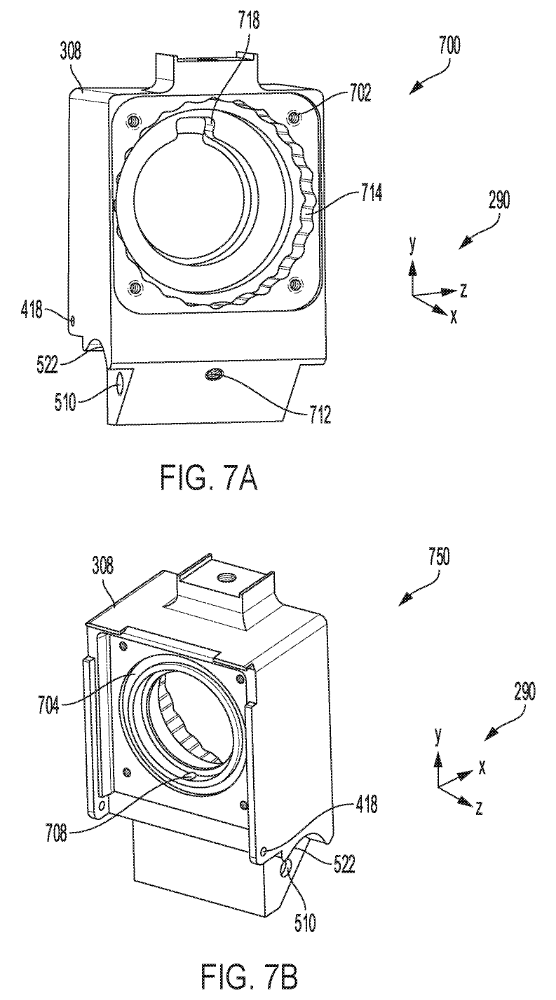

Turning to FIGS. 7A and 7B, the optical housing 308 of the mount assembly 202 is shown in a first view 700 and a second view 750, respectively. The first view 700 shows the side of the optical housing 308 that faces away from the welding site and the second view 750 shows the side of the optical housing 308 that faces toward the welding site.

The port 602 of FIG. 6 may be fluidly coupled to an opening 712 shown in FIG. 7A. The opening 712 may be fluidly coupled via an air pathway to an opening 708 shown in FIG. 7B, as described further below.

The optical housing 308 may include inner ridges 714 wherealong detents (e.g., spring-loaded elements 838 described below) may be depressed and released as rotational motion of one or more components housed by the optical housing 308 relative thereto occurs as described further below.

Turning to FIG. 8, an exploded view 800 of the optical assembly 106 is shown. The optical assembly 106 includes one or more of an optical device 802, a captive plate 804, a first ring 806, a center element 808, a lens 810, a welding glass 812, a second ring 814, a spacer 816, and a coverglass 818.

The optical device 802 may include a conventional camera, or other device adapted to capture images and configure the images in a digital format. The optical device 802 may include one or more visual cameras which detect light in the visible spectrum (around 400nm to 780nm) and/or one or more thermal cameras which detect infrared light (e.g., providing visual of infrared radiation emitted by objects for thermal contrast). The optical device 802 is represented schematically for generalization to various camera types. The optical device 802 may include an optical controller 846 housed by an optical device housing 822. The optical controller 846 may be configured to control acquisition parameters such as frame rate, exposure time, sensor shutter mode, and the like, as well as analog image parameters including black/white balance ratio, pixel size, color filters, region of interest, sharpening, denoising, etc. The optical controller 846 may independently and/or in cooperation with the controller 118 of FIG. 1 execute methods disclosed herein which are described further below.

The optical device 802 may include a lens receptacle 824. The lens receptacle may be a hollow cylindrical protrusion from the optical device housing 822 configured to receive the lens 810. For example, an inner diameter 826 of the lens receptacle 824 may be at least as large as a lens diameter 828 of the lens 810.

The captive plate 804 may be positioned in face-sharing contact with a side 830 of the optical device 802 wherefrom the lens receptacle 824 protrudes. The captive plate 804 may be fastened to the optical housing 308 described above with regard to FIGS. 3-7B via one or more fasteners. For example, screws, bolts, or the like may extend through through-holes of the captive plate 804 and into the openings 702 of the optical housing 308 shown in FIG. 7A.

The first ring 806 may be interposed between the captive plate 804 and the center element 808. The first ring 806 may be constructed of a chemical resistant material such as polytetrafluoroethylene (PTFE), or other material with similar temperature stability, wear resistance, chemical stability, and the like. The first ring 806 may include a slit 832 such that the first ring 806 is a discontinuous ring.

The center element 808 may comprise ridges 834 in a section protruding toward the optical device 802. The center element 808 may further comprise one or more receptacles 836 adapted to each receive a spring-loaded element 838, such as a press-fit ball nose spring plunger. The spring-loaded elements 838 may press against the inner ridges 714 of the optical housing 308, allowing control over rotation of the center element 808 about the optical line 326. As such, the optical line 326 may also be referred to herein as a third axis of rotation.

The welding glass 812 may be pressed against the lens 810 when assembled. The welding glass 812 may protect the lens 810 from thermal degradation which may otherwise result from high temperatures of the welding site being imaged by the optical assembly 106. The welding glass 812 may reduce the intensity of visible and nonvisible light on the camera sensor (e.g., light that reaches the lens 810) during the welding process while maintaining daylight visibility.

The second ring 814 may be constructed of a material capable of withstanding high temperatures generated by the welding operation. For example, the second ring 814 may be silicone O-ring configured to seal an interface between the spacer 816 and the optical housing 308. The second ring 814 may fit into a groove 704 of the optical housing 308 shown in FIG. 7B.

The spacer 816 may space the coverglass 818 from the optical housing 308 as described further below. The coverglass 818 may protect other components of the optical assembly 106, including the welding glass 812 and the lens 810, from smoke and spatter generated during the welding operation. The coverglass 818 may comprise a frame 842 bordering a transparent sheet 844. The transparent sheet 844 of the coverglass 818 may be constructed of quartz, in one example. In other examples, such as where the optical device 802 is a thermal camera, the coverglass 818 may be constructed of a material that is transparent to the wavelengths detected by the opetical dveice 802, such as silicon, ultra-high molecular weight polyethylene (UHMW), germanium, zinc, or the like. The coverglass 818 being constructed of one or more of the aforementioned materials alone may protect the lens 810 better than other means (e.g., , but may not provide a long enough duration where spatter does not obstruct view of the welding site in the images produced by the optical assembly 106. Thus, at least part of the coverglass 818 may be coated in a layer of a repellent material, such as a material that prevents the spatter from sticking to the coverglass 818. The repellent material layer may further be protective of the coverglass 818 in a temperature range of approximately 500-1500F to prevent thermal degradation under high temperatures experienced during welding operations. The repellent material may be applied onto the coverglass 818 prior to assembling optical assembly 106 as a coating of approximately even thickness over the coverglass 818 so as to protect the exposed surfaces of the coverglass 818. The coverglass 818 coated in the repellent material may prolong a use time of the welding system 100 before the images produced by the optical assembly 106 are clouded by spatter accumulated on the coverglass 818 at which point the coverglass 818 may be replaced. Thus, the repellent material coating of the coverglass 818 may extend a lifetime of the coverglass 818, allowing longer periods of continuous time where the operator can better visualize the welding site between maintenance (e.g., replacement of coverglass) and reducing resource demand.

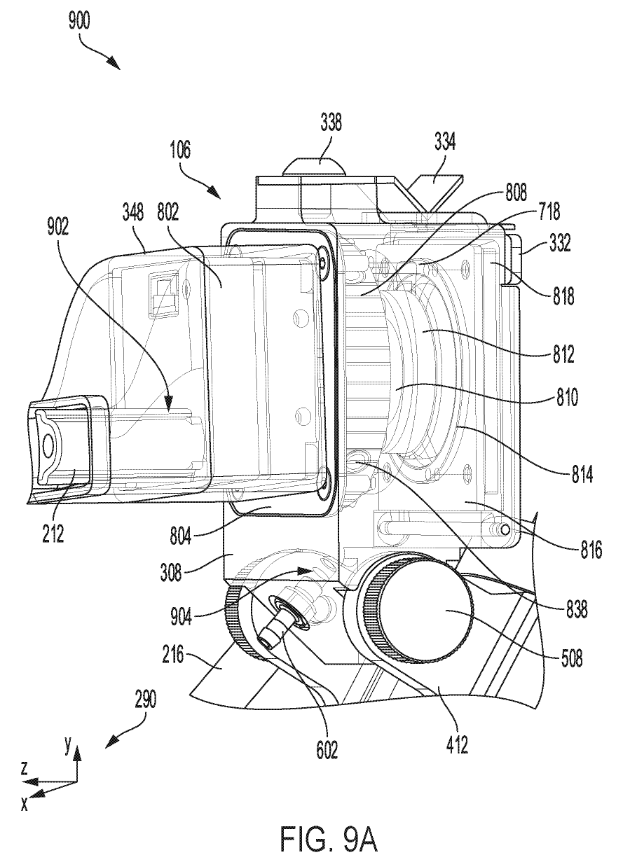

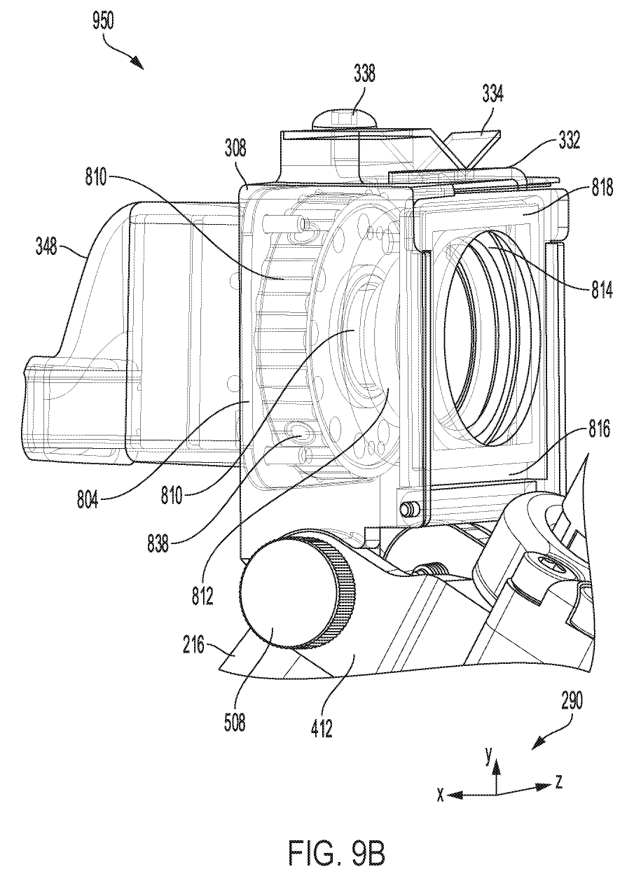

Turning to FIGS. 9A and 9B, assembled views 900 and 950, respectively, of the optical assembly 106 are shown. The optical housing 308, the cover 332, and the second cover 348 are shown as translucent in FIGS. 9A and 9B for visibility of components located therein.

The optical cord 212 may be communicatively coupled to the optical device 802. For example, the optical cord 212 may be electrically and physically coupled to a port 902 of the optical device 802. The optical cord 212 may transmit the information gathered by the optical device 802 to a controller (e.g., controller 118 of FIG. 1) for processing. Additionally or alternatively, the optical device 802 may receive power from a power source via the optical cord 212. The second cover 348 may protect the coupling between the port 902 and the optical cord 212, for example from dust and other debris, as well as mechanical degradation. For example, the shape of the second cover 348 may stabilize the optical cord 212 relative to the optical housing 308, reducing relative movement of the optical cord 212 and the optical device 802.

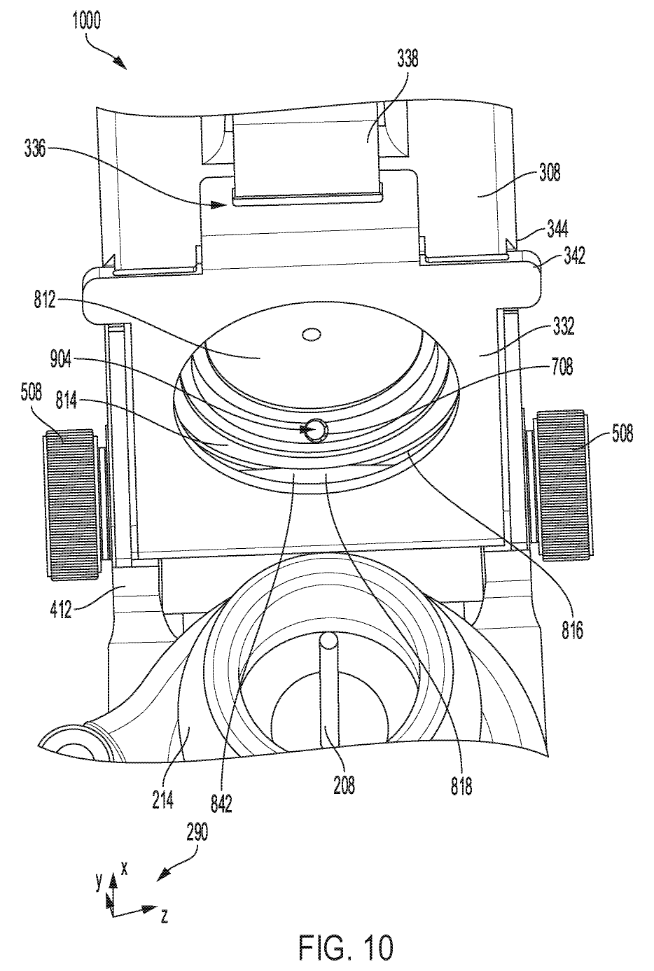

FIG. 9A further shows a pathway 904 in the optical housing 308 wherethrough the pressurized air delivered by the air tube 216 flows. The pathway 904 is more clearly seen in FIG. 10.

Turning to FIG. 10, the optical assembly 106 is shown in a view 1000 from a perspective of a welding site where two components (e.g., the two components 260, 262 of FIG. 2B) are welded together by the welding assembly 104.

The pathway 904 of air through the optical housing 308 may extend linearly from the port 602 toward the opening 708. The view 1000 looks straight down the pathway to the opposite side of the optical assembly 106 where the port 602 of FIGS. 6 and 9A is located. The opening 708 may open to an enclosed space interposed between the welding glass 812 and the coverglass 818. The size of the enclosed space may be determined by the second ring 814 and the spacer 816. Therefore, the pressurized air delivered to the optical assembly 106 via the air tube 216 may be more specifically delivered to the enclosed space. The flow of pressurized air into the optical assembly 106 in this way may actively cool the components bordering the enclosed space between the welding glass 812 and the coverglass 818 (e.g., via convection). In some examples, the air may be chilled (e.g., below ambient temperature) to further cool the surrounding components of the optical assembly 106. The enclosed space may not be hermetically sealed such that the pressurized air is allowed to escape through interfaces between components, such as between the cover 332 and the optical housing 308. The air may further flow through an opening defined by a recess 718 of the optical housing 308.

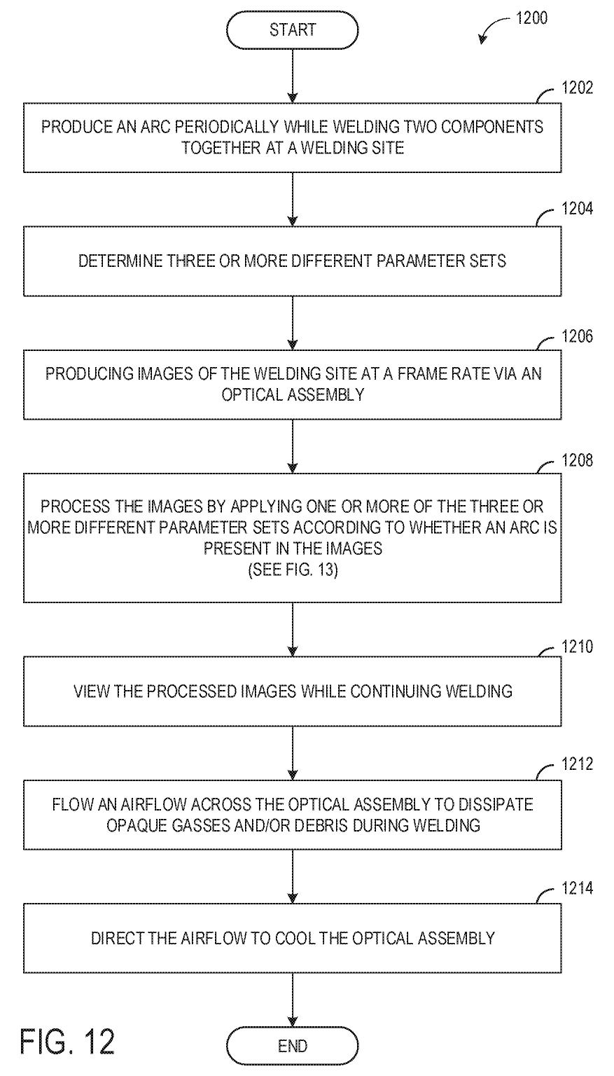

Turning to FIG. 11, a block diagram 1100 is shown. The block diagram 1100 visually represents methods related to operating the welding system of the present disclosure which are described further below. Specifically, the block diagram 1100 shows relationships (e.g., causation, input/output, etc.) between parameters acted upon in the methods disclosed herein. Actions (e.g., characterization, adjusting, configuring, etc.) represented in the block diagram may be carried out automatically via a controller such as the optical controller 846 of FIG. 8 and without input from an operator, for example by executing steps of one or more of the methods of FIGS. 12-15.

Common parameters 1102 (e.g., image size, image offset, frame rate represented as frames per second (FPS), and the like) as well as a frame type specific parameter set 1104 are communicated to the optical assembly 106, such as to the optical controller 846 thereof. The common parameters 1102 may be applied to each image (e.g., each frame) of the plurality of images taken by the optical assembly 106. The common parameters 1102 may be set (e.g., determined and established) upon initialization of the system. The common parameters 1102 may be constant throughout operation, or may vary in some examples. The frame type specific parameter sets 1104 may include one or more parameters (such as parameter 1, parameter 2, and parameter N shown in FIG. 11) which may each have a different value for arc absent (AA), arc present inner (API), and arc present outer (APO) conditions. The frame type specific parameter set 1104 is reconfigured when a change to the image characterization occurs.

Current image characterization 1106 analyzes each image taken by the optical assembly 106 and determines whether an arc is present in the image. The frame type, which is arc present for images where an arc is present or arc not present for images where an arc is not present, is tagged to the current image at 1110. The current image characterization 1106 and the next image characterization 1108 affect the state of the frame type specific parameter set 1104. For example, a number of consecutive images may be characterized as the same type (e.g., arc present or arc not present) before the frame type specific parameter set 1104 is adjusted accordingly. The frame type specific parameter sets 1104 may be optical device settings (e.g., camera settings such as aperture size, exposure rate or shutter speed, etc.) that affect the way the optical assembly 106 operates to capture the images according to whether an arc is present or not. Thus, the image characterizations 1106, 1108 may lead to reconfiguration of the optical assembly 106 during operation thereof in order to increase visibility of the welding site in both conditions where an arc is present and not.

Arc detection 1116 analyzes images 1112 to locate the arc, if present. The location of the arc may be provided to determine a region of interest (ROI) offset 1118. For example, it may be desired that the arc is centered in the ROI. The determination of the ROI offset 1118 may be used to adjust operation of the optical assembly 106 to ensure the images include the ROI. The arc detection 1116 may further be used to adjust the masks 1114. For example, the area of the inner region (e.g., circle in the masks 1114) may be increased or decreased according to the size and/or position of the arc as determined to encompass the entire arc area.

The tag of the frame type applied at 1110 determines the mask 1114 applied to the image 1112. Applying the masks 1114 may include applying a parameter set (e.g., brightness, contrast, saturation, white balance, etc.) to specific subsets of pixels to alter the images 1112 according to the condition being AA, API, or APO. That is, different values for the parameters may be applied on a pixel by pixel basis to images for AA, API, and APO conditions. As indicated in FIG. 11, the mask applied to AA images is consistent for an entire area of the image (e.g., all pixels of the image). The mask applied to API images may affect the pixels in the region of the image within the circle and not outside of the circle. The mask applied to the APO images may affect the pixels in the region outside of the circle and not inside the circle. The regions covered by the masks for the API and APO images may not overlap and if combined may affect the entire image such that the regions are inverses of each other, as indicated by the reverse shading. In other examples, there may be additional masks for additional regions such that three or more parameter sets are applied to the regions.

Following the application of the masks 1114 to the images 1112 according to whether the arc is present, rotation 1120 of the image may occur prior to displaying the image via a display high-definition multimedia interface (HDMI) 1122 (e.g., optical cord 212) and/or a real-time streaming protocol (RSTP) server 1124. The RSTP server 1124 may display the processed images on an augmented or virtual reality display device for view by the operator, in one example.

Turning to FIG. 12, a flowchart of a method 1200 is shown for operating a welding system of the present disclosure, such as the welding system 100 of FIG. 1. An operator may operate the welding system to weld two or more components together in order to better visualize the welding site in real time, including before, during, and following arcs produced by the welding operations. The welding system may comprise a welding assembly configured for any welding type that produces an arc.

The method 1200 begins at 1202, wherein an arc is produced periodically while welding the two components together at a welding site. For example, electricity flowed through the welding assembly in response to the operator depressing a trigger may initiate the arc formation. The arc may be present at some parts of the duration of operation of the welding assembly. The arc may not be present at other parts of the duration of operation of the welding assembly.

The method 1200 proceeds to 1204, wherein three or more different parameter sets are determined. The parameter sets are sets of image parameters that are applied to images in subsequent steps of the method 1200. The parameter sets may be pre-determined and stored in memory of a controller (e.g., the optical controller 846 of FIG. 8 or the controller 118 of FIG. 1). Additionally or alternatively, the controller may determine the parameter sets during execution of the method 1200. Parameter sets may be described as different if the parameter sets contain at least one mismatched parameter. For example, if exposure is a high value in a first parameter set, and a low value in a second parameter set, the parameter sets may be described as different parameter sets, regardless of the other parameter values of the sets.

The method 1200 proceeds to 1206, wherein images of the welding site are produced at a frame rate (e.g., frames per second (FPS)). For example, the optical assembly 106 may image the welding side at 25-180 frames per second such that 25-180 images are produced per second. Other frame rates outside of the provided example range are also possible. Producing the images may include digitizing visual information regarding the welding site which may be translated into a display in later steps of the method 1200. The images may include thermal images, in some examples.

The method 1200 proceeds to 1208, wherein one or more of the three or more different image parameter sets is applied to the images according to whether an arc is present in the images. Applying parameter sets to an image may include adjusting settings of the optical device which takes the images (e.g., optical device 802) in order to alter how the next image is captured (e.g., different exposure time) such as by changing the frame type specific parameter sets 1104 of FIG. 4. Additionally or alternatively, applying parameter sets to an image may include adjusting the image after being taken, such as by adjusting contrast, brightness, colors, etc., for example by applying the corresponding masks 1114 of FIG. 11. Thus, whether applying parameters of the respective parameter sets affects the optical device settings or the images directly may depend on the parameter being applied.

It may be determined that an arc is present in an image if an area of a contour of the image that exceeds a threshold brightness (e.g., approximately 240-260 for an 8-bit color camera, or approximately 1015-1035 for a 10-bit color camera) is greater than a threshold area (e.g., approximately 35-55 percent of the displayed image size). Alternatively, it may be determined that an arc is not present in an image if there is no contour of size over the threshold area where all of the pixels within the contour is over the threshold brightness. The threshold area may be chosen empirically. If the percentage is too high, the detection of an arc is delayed until it grows in size and exceeds the percentage threshold. During such a delayed interval where the arc is actually present, but the algorithm has not detected it, the operator is subjected to images that are too bright. If the percentage is too low, false positives may occur. For example, a bright spot on the work surface when illuminated with a flashlight might falsely register as an arc start. Triggering the display transition to the dual region mode before an arc actually exists may make it difficult for the operator to see the work area and position the torch before arc initiation. As an example, the threshold area percentage may be 40%, though others may be determined by empirical testing.

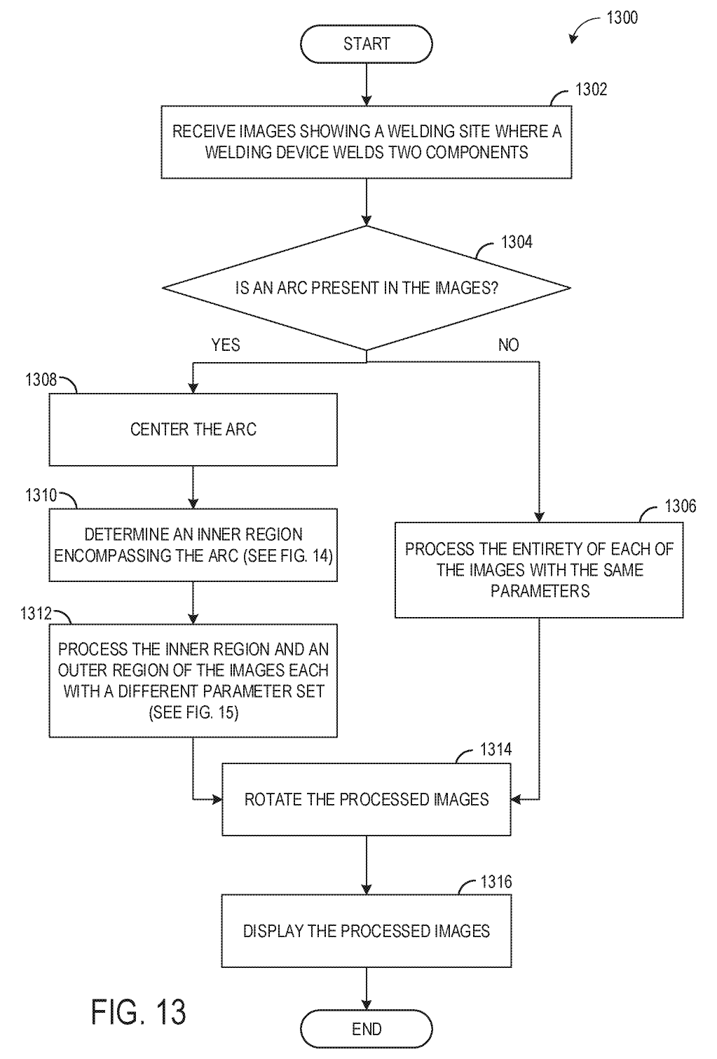

If for a number of consecutive images (e.g., two or more), it is determined that an arc is present, then a first parameter set may be applied to a first region encompassing the arc and a second parameter set may be applied to a second region not overlapping with the arc. The first and second regions may not overlap with each other. The first and second regions may together comprise the entire area of the images. Alternatively, if for a number of consecutive images, it is determined that an arc is not present, then a third parameter set may be applied to the entire image. The first, second, and third parameter sets may be different from each other. Further details as to processing the images according to whether an arc is present are provided with regard to FIG. 13. By monitoring whether an arc is present in the images, and processing the images with parameters sets accordingly, the optical assembly may continuously and automatically adapt to the changing visual conditions in order to increase quality of the display provided to the operator, thereby increasing ability of the operator to perform the desired welding operations.

The method 1200 proceeds to 1210, wherein the operator views the processed images while continuing welding. For example, the operator may view the processed images via an augmented reality display. In another example, the operator may view the processed images via a virtual reality display. The augmented or virtual reality display may be communicatively coupled to the controller that executes the automated steps of the method 1200 (e.g., 1204, 1206, 1208). More specifically, the augmented or virtual reality display may be wirelessly coupled to the controller, in at least some examples.

The method 1200 proceeds to 1212, wherein an airflow is flowed across the optical assembly to dissipate opaque gasses and/or debris during welding. The airflow may be delivered to the optical assembly via an air tube coupled to the mount assembly, such as the air tube 216, as an example. The airflow may flow around components of the optical assembly, including a lens (e.g., lens 810) and a coverglass (e.g., coverglass 818), as well as the mount assembly, including an optical housing (e.g., optical housing 308) which houses the optical assembly.

The method 1200 proceeds to 1214, wherein the airflow is further directed to cool the mount assembly. For example, the airflow may travel through a pathway through the optical housing of the mount assembly (e.g., pathway 904 of FIGS. 9A-10) to an area within the optical assembly (e.g., within the optical housing), thereby cooling the components of the optical assembly. Specifically, the airflow may be directed into an enclosed space between the lens and the coverglass. The airflow may further flow through an opening between the lens and the optical housing, such as an opening defined in part by the recess 718 of FIG. 7A. In this way, the airflow may be directed throughout the inside of the optical housing, thereby cooling the components located therein.

The method 1200 ends after 1214, when operation of the welding system ends. By performing the method 1200, the operator may be more likely to successfully weld the two or more components than by operating other welding systems, for example systems which do not include an optical assembly and/or do not process the images differently according to whether an arc is present in the images.

Turning to FIG. 13, a flowchart of a method 1300 is shown for processing images taken during welding according to whether an arc is present in the images. Some or all steps of the method 1300 may be executed as part of the method 1200, as noted above. The method 1300 may also be executed independently of the method 1200 without departing from the scope of the present disclosure. Instructions for executing the method 1300 may be stored in memory of a controller (e.g., the controller 118 of FIG. 1 or the optical controller 846 of FIG. 8) and executed automatically by the controller.

The method 1300 begins at 1302, wherein images are received, the images showing a welding site where a welding device (e.g., welding device 102 of FIG. 1) welds two components. The welding device may include an optical assembly (e.g., optical assembly 106) configured to take the images and communicate the image information to the controller executing the method 1300. The images may be taken by a visual camera and/or a thermal camera. The images may be captured and received at a frame rate suitable for a video display, such as 25-180 frames per second. Each image may be processed based on whether an arc is present in real-time (e.g., without an intentional delay) at the frame rate.

The method 1300 proceeds to 1304, wherein it is determined whether an arc is present in each of the images. As described above, it may be determined that an arc is present if for more than a first threshold number of consecutive images (e.g., a number equal to half of the frame rate), a contour is present containing pixels all over a threshold brightness and the contour covers a continuous area over a threshold area. Alternatively, it may be determined that an arc is not present if for more than a second threshold number of consecutive images (which may be different from the first number of consecutive images to determine the arc is present), the images do not include a contour of greater than the threshold area having pixels all brighter than the threshold brightness. By demanding a threshold number of consecutive images to change the determination of whether the arc is present or not, the mode of the image processing may change less frequently, increasing quality of the processed images, and therefore the visibility of the welding site by the operator. Additionally or alternatively to the number of consecutive images, an amount of time (e.g., one second) may pass before the status of the arc is changed (e.g., from present to not present, or vice versa).

If an arc is not present (NO at 1304), the method proceeds to 1306, wherein an entire area of each of the images is processed with the same parameters. For example, a single parameter set may be applied to the entire image area. The single parameter set may be a high exposure parameter set to counteract the relatively dim lighting in the absence of the arc.

Alternatively, if an arc is present (YES at 1304), the method 1300 proceeds to 1308, wherein the arc is automatically centered. For example, a center of the contour found in determining the arc is present may be compared to determine an offset (e.g., as described with reference to arc detection 1116 of FIG. 11). If the size (e.g., pixel dimensions) of the image provided by the optical assembly is larger than the size of a display where the image will be shown at a subsequent step of the method 1300, part but not all of the image is displayed, and the displayed area may be shifted by the offset to autocenter the arc with respect to the display. As a more specific example, if the optical assembly is able to provide 1920x1080 images and the display is 640x480, a portion with dimensions 640x480 of the image provided by the optical assembly (which is up to 1920x1080) is displayed. A center of the portion may be shifted such that the center coincides with the center of the contour comprising pixels brighter than the threshold. In this way, the offset (e.g., in x and y directions) may be used to adjust the location of the part of the image displayed such that the arc is centered when displayed in subsequent steps of the method 1300. The correction to centering may not be allowed until after an amount of time (e.g., 5 seconds) has passed after an arc is detected, or after the operator has manually inputted information indicating the start of an arc (e.g., via the operator input interface 132 of FIG. 1). In this way, excessively frequent image shifts which may be distracting to the operator may be prevented. There may also be an interface (e.g., button pressable in the operator input interface) for the operator to reset the offsets to avoid a shift of the center. For example, if an arc is detected when no arc is actually present (e.g., a false positive arc detection), the button press may reset the camera offsets such that there is not a shift in center for another period of time (e.g., 5 seconds). Such an option may be useful in the case of a false positive arc detection, such as when the operator uses a flashlight when visualizing the welding site. To elaborate, a bright spot from the flashlight on the work material may be falsely identified as an arc, which may trigger an erroneous offset correction.

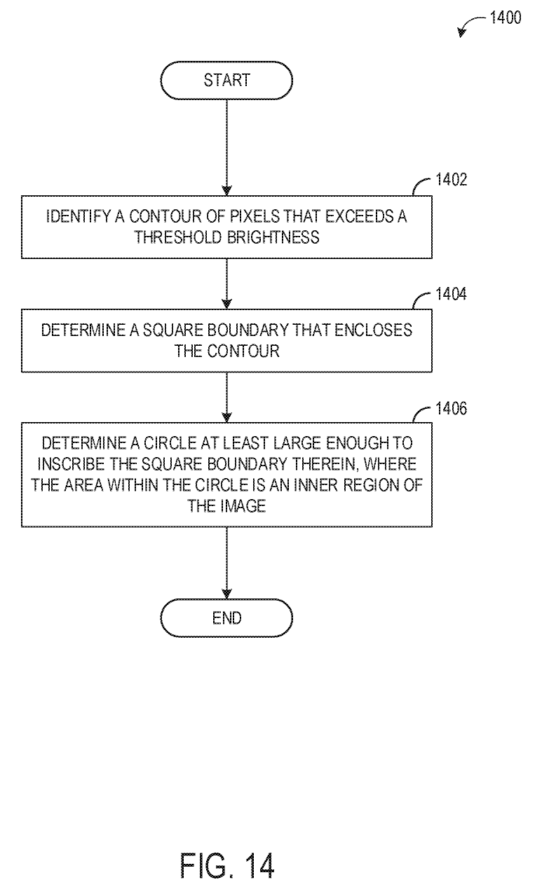

Following 1308, the method 1300 proceeds to 1310, wherein an inner region encompassing the arc is determined. The inner region may be a region of the image containing the arc. The arc may not extend out of the inner region. However, the inner region may contain areas where the arc is not present. As an example, the method of FIG. 14 which is described further below may be executed in order to complete 1308. However, other methods may be used to determine the inner region. As described further below, different parameter sets may be applied to the inner region and an outer region not overlapping the inner region in subsequent steps of the method 1300 to better visualize the weld pool and the surrounding context.

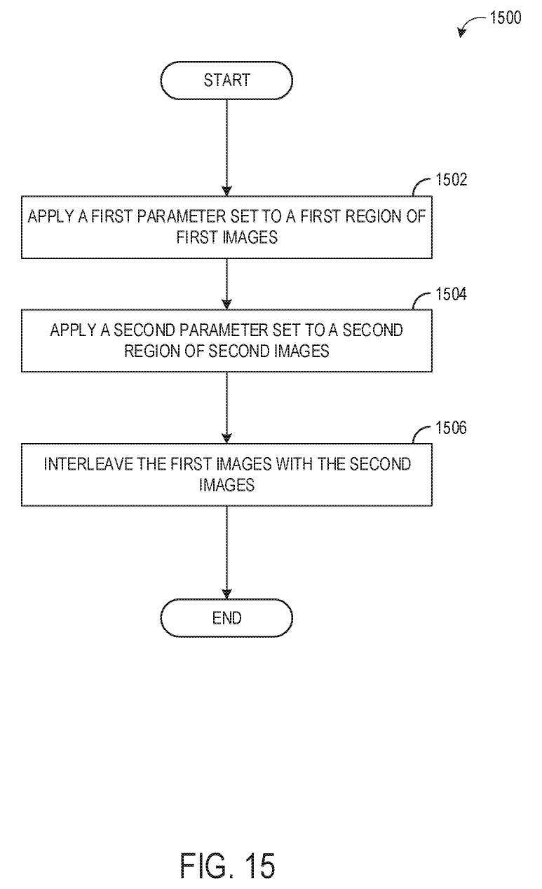

The method 1300 proceeds to 1312, wherein the inner region and an outer region of the images are processed each with a different parameter set. For example, a first parameter set may be applied to the inner region and a second parameter set may be applied to the outer region. The inner and outer regions may together form the entire image. The inner region and outer region may not overlap. In some examples, there may be one or more additional regions such that three or more regions are processed with different parameter sets. As an example, the method of FIG. 15 which is described further below may be executed to complete 1312. However, other methods may be used alternatively to process the inner region and the outer region of the images with different parameter sets.

After 1306 or 1312, the method 1300 proceeds to 1314, wherein the images are rotated. The images may be rotated identically, in some examples. Alternatively, the images may be rotated different directions and/or different degrees from each other. The images may be rotated according to operator input (e.g., via the operator input interface 132 of FIG. 1).

The method 1300 proceeds to 1316, wherein the processed images are displayed. The processed images may be displayed on glasses, a headset, or the like in an augmented or virtual reality display viewable by the operator, as described above. Displaying the processed images may include transmitting the data via an electrical coupling or wirelessly to the display which may translate the data into visual format. The processed images are displayed in temporal order. That is, the images may be displayed in the order they were captured. In some examples images taken concurrently may be overlaid with each other. For example, a mixture of thermal and visual images may be alternated in the display to visually combine the information provided by both imaging types. The method 1300 ends. The method 1300 may be repeated continuously during operation of the welding assembly and/or some steps of the method 1300 may be performed concurrently.

Turning to FIG. 14, a flowchart of a method 1400 is shown for determining a region of the image encompassing the arc. The method 1400 may be executed as part of the method 1300, as noted above. Thus, some or all steps of the method 1400 may be included in the method 1300 and/or the method 1200, in some examples. The method 1400 may also be executed independently of the methods 1200 and 1300. Instructions for executing the method 1400 may be stored in memory of a controller (e.g., the controller 118 of FIG. 1 or the optical controller 846 of FIG. 8).

The method 1400 begins at 1402, wherein a contour of pixels that exceeds a threshold brightness and a threshold area is identified. The contour of pixels may represent the arc in the image.

The method 1400 proceeds to 1404, wherein a square boundary that encloses the contour is determined. The square boundary may be the minimum size to surround the contour without the contour extending out of the boundary.

The method 1400 proceeds to 1406, wherein a circle at least large enough to inscribe the square boundary therein is determined, where the area within the circle is an inner region of the image. The method 1400 ends. While described herein as a circle, the inner region may be other shapes in other examples.

Turning to FIG. 15, a method 1500 is shown for processing two or more regions of the image each with a different parameter set. The method 1500 may be executed as part of the method 1300, as noted above. Thus, some or all steps of the method 1500 may be included in the method 1300 and/or the method 1200, in some examples. The method 1500 may also be executed independently of the methods 1200 and 1300 without departing from the scope of the present disclosure. Instructions for executing the method 1400 may be stored in memory of a controller (e.g., the controller 118 of FIG. 1 or the optical controller 846 of FIG. 8).

The method 1500 begins at 1502, wherein a first parameter set is applied to a first region of first images. For example, referencing FIG. 11, the API mask may be applied to the inner region (e.g., inside the circle) of the first images.

The method 1500 proceeds to 1504, wherein a second parameter set is applied to a second region of second images. For example, referencing FIG. 11, the APO mask may be applied to the outer region (e.g., outside the circle) of the second images. The second images may alternate chronologically with the first images. For example, for an image set including image 1, image 2, image 3, and image 4 taken in that order, the first images may include images 1 and 3, and the second images may include images 2 and 4.

The method 1500 proceeds to 1506, wherein the first and second images are interleaved. For example, the first region of the first images and the second region of the second images are displayed concurrently while the second region of the first images and the first region of the second images are not shown. Thus, the displayed frame rate may be half of the frame rate of the optical device. In an example where the frame rate is 60 FPS, after interleaving in this way, the two regions in the composite image comprising the first region of the first images and the second region of the second images are both updated at 30 FPS. The method 1500 ends after interleaving.

The technical effect of the welding system and methods disclosed herein is to expand image processing capability of responding to periodic arcs in order to increase visibility of a welding site for an operator of the welding system. The optical assembly of the welding system captures images which are processed to increase clarity of the images by autocentering the arc in the display, rotating the image in the display, and adjusting and/or combining parameters according to whether an arc is present in real-time, thereby accounting for exposure changes as the arc appears and disappears.

The disclosure also provides support for a welding system, comprising: a welding assembly configured to weld two components at a welding site, and an optical assembly coupled the welding assembly via a mount assembly, where the optical assembly is configured to image the welding site and includes a coverglass coated in a repellent material resistant to heat and spatter produced by welding. In a first example of the system, the welding system further comprises a cooling system including an air tube fluidly coupled to a pathway through an optical housing that houses the optical assembly. In a second example of the system, optionally including the first example, the pathway is fluidly coupled to an enclosed space between the coverglass and a lens of the optical assembly. In a third example of the system, optionally including one or both of the first and second examples, the welding system further comprises a display device adapted to display the images in augmented reality format. In a fourth example of the system, optionally including one or more or each of the first through third examples, the optical assembly is housed by an optical housing and the coverglass is retained against the optical housing by a cover removable from the optical housing. In a fifth example of the system, optionally including one or more or each of the first through fourth examples, the coverglass is constructed of quartz and the repellent material comprises silicone. In a sixth example of the system, optionally including one or more or each of the first through fifth examples, the welding assembly is an arc welding assembly. In a seventh example of the system, optionally including one or more or each of the first through sixth examples, the welding system further comprises a controller with instructions stored in non-volatile memory thereof and executable to process the images by applying one or more of three or more different parameter sets according to whether an arc is present in the images.

The disclosure also provides support for an optical assembly of a welding system, comprising: an optical device, a lens, and a coverglass coated in a layer of repellent material. In a first example of the system, the optical assembly is housed by an optical housing coupled to a cover that retains the coverglass. In a second example of the system, optionally including the first example, the optical assembly further comprises a spacer in face-sharing contact with the coverglass that spaces the coverglass from a surface of the optical housing comprising an opening to a pathway for compressed air. In a third example of the system, optionally including one or both of the first and second examples, the optical assembly further comprises a welding glass positioned against the lens. In a fourth example of the system, optionally including one or more or each of the first through third examples, the coverglass is constructed of quartz. In a fifth example of the system, optionally including one or more or each of the first through fourth examples, the optical device includes a thermal camera and the coverglass is constructed of ultra-high molecular weight polyethylene, germanium, zinc, or the like.

The disclosure also provides support for a mount assembly for coupling an optical assembly to a welding assembly, comprising: a first nozzle mount and a second nozzle mount circumferentially surrounding and rotationally coupled to a nozzle of the welding assembly, a yoke interposed between the first nozzle mount and the second nozzle mount and circumferentially surrounding the nozzle, wherein the yoke is coupled to the first nozzle mount and the second nozzle mount via a fastening system that selectively allows relative rotation about a first axis of rotation, and an optical housing that houses the optical assembly, wherein the optical housing is coupled to the yoke via one or more joints that selectively allow rotation about a second axis of rotation normal to the first axis of rotation. In a first example of the system, the optical housing is further coupled to a cover that retains a coverglass of the optical assembly within the optical housing when in a secured position. In a second example of the system, optionally including the first example, the cover is coupled to the optical housing by a hinge and a clip which is in the secured position when the clip is received by an opening of the cover. In a third example of the system, optionally including one or both of the first and second examples, the optical housing includes circumferentially arranged inner ridges where spring-loaded elements coupled to a center element of the optical assembly press against to regulate rotation of the center element within the optical housing about a third axis of rotation. In a fourth example of the system, optionally including one or more or each of the first through third examples, the optical housing includes a pathway for compressed air therethrough from a side facing away from a welding site to a side facing toward the welding site. In a fifth example of the system, optionally including one or more or each of the first through fourth examples, adjusting the fastening system and the joints positions the third axis of rotation relative to the first and second axes of rotation.

The disclosure also provides support for a method for operating a welding system, comprising: producing an arc periodically while welding two components together at a welding site, determining three or more different parameter sets, producing images of the welding site at a frame rate, and processing the images by applying one or more of the three or more different parameter sets according to whether an arc is present in the images. In a first example of the method, the method further comprises viewing the processed images while continuing welding. In a second example of the method, optionally including the first example, processing the images includes determining whether an arc is present in the images, and if it is determined that an arc is not present, processing an entire area of each of the images with the same parameters. In a third example of the method, optionally including one or both of the first and second examples, if it is determined that an arc is present, processing the images includes centering the arc. In a fourth example of the method, optionally including one or more or each of the first through third examples, if it is determined that an arc is present, processing the images includes determining an inner region encompassing the arc. In a fifth example of the method, optionally including one or more or each of the first through fourth examples, if it is determined that an arc is present, processing the images further includes processing the inner region and an outer region of the images each with a different parameter set. In a sixth example of the method, optionally including one or more or each of the first through fifth examples, it is determined that an arc is present in the images if the images include a contour of over a threshold area and a threshold brightness. In a seventh example of the method, optionally including one or more or each of the first through sixth examples, it is determined that an arc is not present in the images if the images do not include a contour of over a threshold area and a threshold brightness. In an eighth example of the method, optionally including one or more or each of the first through seventh examples, processing the images further includes rotating and displaying the images.

The disclosure also provides support for a method for operating a welding system, comprising: determining whether an arc is present in images showing a welding site, and if it is determined that an arc is present, applying a first parameter set to a first region of first images and applying a second parameter set to a second region of second images. In a first example of the method, the method further includes if an arc is not present, applying a third parameter set to an entire area of each of the images. In a second example of the method, optionally including the first example, it is determined that an arc is present in an image if an area of a contour of the image that exceeds a threshold brightness is greater than a threshold area In a third example of the method, optionally including one or both of the first and second examples, the first, second, and third parameter sets are different from each other. In a fourth example of the method, optionally including one or more or each of the first through third examples, the method further comprises interleaving the first and second images. In a fifth example of the method, optionally including one or more or each of the first through fourth examples, the first region encompasses the arc and the second region does not overlap the arc or the first region.

The disclosure also provides support for a welding system, comprising: a welding device including a welding assembly and an optical assembly, and a controller with instructions stored in non-volatile memory and executable to process images taken by the optical assembly according to whether an arc is present in the images. In a first example of the system, the instructions are further executable to display the images via an augmented reality display device. In a second example of the system, optionally including the first example, the instructions are further executable to automatically center the arc in a display. In a third example of the system, optionally including one or both of the first and second examples, when an arc is present in the images, the instructions are further executable to: determine an inner region of the images, and process the inner region and an outer region of the images with different parameter sets. In a fourth example of the system, optionally including one or more or each of the first through third examples, determining the inner region comprises: identifying a contour of pixels that exceeds a threshold brightness and a threshold area, determining a square boundary that encloses the contour, and determining a circle at least large enough to inscribe the square boundary therein, where the area within the circle is the inner region of the image.

The disclosure also provides support for a method for operating a welding system, comprising: producing an arc to weld two or more components together at a welding site via a welding device; capturing images of the arc from an optical assembly mounted to the welding device via a mount assembly; flowing an airflow across the optical assembly to dissipate opaque gasses and/or debris during welding; and directing the airflow to cool the optical assembly. In a first example of the system the airflow is directed through a pathway through the optical housing of the mount assembly to an area within the optical housing. In a second example of the system, optionally including the first example, the airflow is delivered to the optical assembly via an air tube coupled to the mount assembly. In a third example of the system, optionally including one or both of the first and second examples, the images are processed differently in an inner region encompassing the arc and an outer region not overlapping the arc.

FIGS. 1-10 show example configurations with approximate position. FIGS. 2-10 are shown approximately to scale; though other relative dimensions may be used. As used herein, the terms “approximately” is construed to mean plus or minus five percent of the range unless otherwise specified.

If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis and a vertical axis. Features described as lateral may be approximately parallel with the lateral axis. A vertical axis may be normal to a lateral axis and a longitudinal axis. Features described as vertical may be approximately parallel with a vertical axis.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for operating a welding system, comprising:
producing an arc periodically while welding two or more components together at a welding site;
capturing images of the welding site at a frame rate; and
processing and displaying the images by applying one or more of three or more different parameter sets according to whether an arc is present in the images.

2. The method of claim 1, wherein processing the images includes determining whether an arc is present in the images, and in response to determining that an arc is not present, processing an entire area of each of the images with the same parameters.

3. The method of claim 2, wherein in response to determining that an arc is present, processing the images includes centering the arc.

4. The method of claim 2, wherein in response to determining that an arc is present, processing the images includes determining an inner region encompassing the arc.

5. The method of claim 4, wherein in response to determining that an arc is present, processing the images further includes processing the inner region and an outer region of the images each with a different parameter set.

6. The method of claim 1, wherein it is determined that an arc is present in the images if the images include a contour of over a threshold area and a threshold brightness.

7. The method of claim 1, wherein it is determined that an arc is not present in the images if the images do not include a contour of over a threshold area and a threshold brightness.

8. The method of claim 1, wherein processing the images further includes rotating the images, and wherein the images are displayed via a virtual reality display.

9. A method for operating a welding system, comprising:
determining whether an arc is present in images showing a welding site;
in response to determining that an arc is present, applying a first parameter set to a first region of first images and applying a second parameter set to a second region of second images; and
displaying the images for view by an operator of the welding system.

10. The method of claim 9, wherein the method further includes in response to determining an arc is not present, applying a third parameter set to an entire area of each of the images.

11. The method of claim 9, wherein it is determined that an arc is present in an image if an area of a contour of the image that exceeds a threshold brightness is greater than a threshold area.

12. The method of claim 10, wherein the first, second, and third parameter sets are different from each other.

13. The method of claim 9, wherein the method further comprises interleaving the first and second images.

14. The method of claim 9, wherein the first region encompasses the arc and the second region does not overlap the arc or the first region.

15. A welding system, comprising:
a welding device including a welding assembly and an optical assembly; and
a controller with instructions stored in non-volatile memory and executable to process images taken by the optical assembly according to whether an arc is present in the images and display the processed images.

16. The welding system of claim 15, wherein the images are displayed via an augmented reality display device.

17. The welding system of claim 15, wherein the instructions are further executable to automatically center the arc in a display.

18. The welding system of claim 15, wherein the instructions are further executable to:
in response to detecting an arc in the images:
determine an inner region of the images; and
process the inner region and an outer region of the images with different parameter sets.

19. The welding system of claim 18, wherein determining the inner region comprises:
identifying a contour of pixels that exceeds a threshold brightness and a threshold area;
determining a square boundary that encloses the contour; and
determining a circle at least large enough to inscribe the square boundary therein, where the area within the circle is the inner region of the image.

20. The welding system of claim 15, wherein the instructions are further executable to:
in response to detecting an absence of an arc in the images, process an entire area of the images with the same parameter set.
